(19) United States
(12) Patent Application Publication
(10) Pub. No.: US 2019/0069180 A1
(43) Pub. Date: Feb. 28, 2019

(54) EXECUTING MOBILE APPLICATIONS WITH ACTIVITY THRESHOLDS

(71) Applicant: Isaac Gredinberg, San Jose, CA (US)

(72) Inventor: Isaac Gredinberg, San Jose, CA (US)

(21) Appl. No.: 16/046,935

(22) Filed: Jul. 26, 2018

Related U.S. Application Data
(60) Provisional application No. 62/549,959, filed on Aug. 25, 2017.

(51) Int. Cl. H04W 12/08

(52) U.S. Cl. CPC H04W 12/08; H04L 63/0272

(57) ABSTRACT

A system and a method that executes mobile applications with activity threshold parameters. The activity thresholds may be communicated from a senior mobile device to a junior mobile device via a remote server. The senior mobile device may manage the junior mobile device, applications thereon and associated user based on said activity thresholds.

### BACKGROUND

Smartphones have become ubiquitous. One reason for this ubiquity is attributable to smartphone applications. The functionality, and the versatility of smartphone applications can be appealing to children and adolescents in particular, who then typically engage with social media apps and other such applications long periods of time, resulting physical inactivity and undesirable health consequences for many such children. Because each smartphone application typically points to a different server, this raises the technical challenge (among others) of how such smartphone applications pointing to different servers can monitored. The larger the number of smartphone applications on a child's device, the more the number of remote servers that are referenced by the smartphone applications.

It is within the aforementioned context that a need for the present disclosure has arisen. Thus, there is a need to address one or more of the foregoing disadvantages of conventional systems and methods, and the present disclosure meets this need.

### BRIEF SUMMARY

Various aspects of executing mobile applications with activity thresholds can be found in exemplary embodiments of the present disclosure. In one aspect, a system includes comprises a remote server incorporating a processor and memory; and a senior mobile device also incorporating a processor and memory. The system includes a junior mobile device incorporating a processor and memory as well. The junior mobile device is communicably coupled through the remote server to the senior mobile device. The junior mobile device executes one or more mobile applications based on a user input signal from a user of said junior mobile device to execute the one or more mobile applications.

The system also includes an activity requirement module executed on the senior mobile device and on said junior mobile device. The activity requirement module of the senior mobile device sends at least one predetermined activity threshold or parameter, via the remote server, to the junior mobile device. The activity threshold or parameter is to be met by the junior mobile device user.

Upon receiving the user input signal to execute the one or more mobile applications, the activity requirement module of the junior mobile device uses an activity tracker module to determine whether the least one predetermined activity threshold or parameter is met. If the threshold is met, at least one mobile application is executed to permit access by the junior mobile device user. If said at least one predetermined activity threshold or parameter is not met, access to the one or more mobile applications is disabled or denied. In another embodiment, the system includes a VPN server that creates a virtual private network through which all network traffic from each junior mobile device is routed. The VPN server is configured to disable or deny access to the one or more mobile applications.

A further understanding of the nature and advantages of the present disclosure herein may be realized by reference to the remaining portions of the specification and the attached drawings. Further features and advantages of the present disclosure, as well as the structure and operation of various embodiments of the present disclosure, are described in detail below with respect to the accompanying drawings. In the drawings, the same reference numbers indicate identical or functionally similar elements.

### BRIEF DESCRIPTION OF THE DRAWINGS

FIG. 1 illustrates a simplified diagram of a mobile device that may incorporate one or more embodiments.

FIG. 2A is a flowchart illustrating a method for configuring an activity threshold or parameter, according to some embodiments.

FIG. 2B is a flowchart illustrating a method for mobile application access based on an activity threshold or parameter, according to some embodiments.

FIG. 3 illustrates an example of a computing system in which one or more embodiments may be implemented.

FIG. 4A illustrates an activity threshold execution system according to another exemplary embodiment of the present disclosure.

FIG. 4B illustrates an activity threshold execution system including a VPN server according to another exemplary embodiment of the present disclosure.

FIG. 5A is a system display interface for designating the user of a mobile device according to an exemplary embodiment of the present disclosure.

FIG. 5B shows a “Parent Dashboard” according to an exemplary embodiment of the present disclosure.

FIG. 6 shows the “Parent Dashboard” of FIG. 5B showing controlled junior mobile devices according to an exemplary embodiment of the present disclosure.

FIG. 7A illustrates an interface for setting various parameters for a junior mobile device according to an exemplary embodiment of the present disclosure.

FIG. 7B shows an interface for manual entry of activity threshold parameters according to an embodiment of the present disclosure.

FIG. 7C shows an interface for setting daily and hourly activity thresholds according to an exemplary embodiment of the present disclosure.

FIG. 7D illustrates a block list that can be set via a senior mobile device according to an exemplary embodiment of the present disclosure.

FIG. 8 shows a notification that an activity threshold is attained according to an exemplary embodiment of the present disclosure.

FIG. 9 shows a notification that an activity threshold is not met according to an exemplary embodiment of the present disclosure.

### DETAILED DESCRIPTION

Reference will now be made in detail to the embodiments of the disclosure, examples of which are illustrated in the accompanying drawings. While the disclosure will be described in conjunction with the one embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth to provide a thorough understanding of the present disclosure. However, it will be obvious to one of ordinary skill in the art that the present disclosure may be practiced without these specific details. In other instances, well-known methods, procedures, components, and circuits have not been described in detail as to not unnecessarily obscure aspects of the present disclosure.

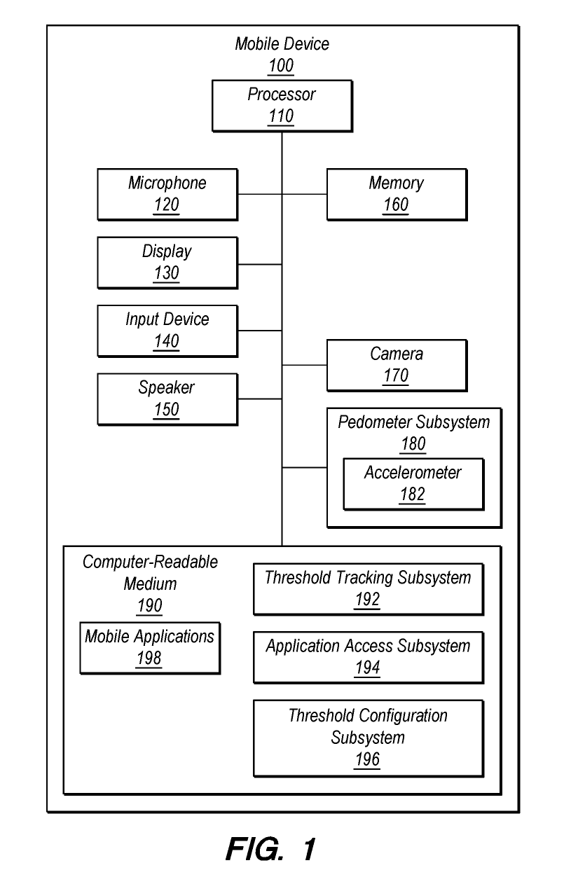

FIG. 1 illustrates a simplified diagram of a mobile device 100 that may incorporate one or more embodiments.

In FIG. 1, mobile device 100 may include a processor 110, microphone 120, display 130, input device 140, speaker 150, memory 160, camera 170, pedometer subsystem 180, and computer-readable medium 190. In one embodiment, the processor 110 is coupled to other units of the mobile device 100 including microphone 120, display 130, input device 140, speaker 150, memory 160, camera 170, pedometer subsystem 180, and computer-readable medium 190.

Microphone 120 may be any device that converts a sound input to an electrical signal. The microphone 120 may capture a user's voice or any other sound in a proximity to the mobile device 100. Display 130 may be an LCD screen, CRT monitor, or seven-segment display. In some embodiments, display 130 may be a touchscreen display capable of receiving input from a user. Input device 140 may be any device that accepts input from a user. Examples may include a keyboard, keypad, mouse, or touch input. In some embodiments, display 130 may also function as input device 140.

Speaker 150 may be any device that outputs sound to a user. Examples may include a built-in speaker or any other device that produces sound in response to an electrical audio signal. Memory 160 may be any magnetic, electronic, or optical memory. An example of memory 160 may be dynamic random access memory (DRAM).

Camera 170 may be configured to capture one or more images. The captured images may be still images or video images. Pedometer subsystem 180 may be configured to count each step a user of the mobile device 100 takes based on detected motion of the mobile device 100. The pedometer subsystem 180 may include an accelerometer 182 that detects the motion of the mobile device 100 while, for example, the mobile device 100 is being held by the user or placed in the user's pocket. Computer-readable storage medium 190 may store computer-readable code comprising code subsystems, including threshold tracking subsystem 192, application access subsystem 194, and threshold configuration subsystem 196.

Threshold tracking subsystem 192 contains code that, when executed by processor 110, may track an activity threshold or parameter of a first user of the mobile device 100. In some embodiments, the activity threshold or parameter may be a number of steps taken by the first user 100 over a predetermined time period. For example, the activity threshold or parameter may be 3000 steps over a 12-hour period. The threshold tracking subsystem 192 may interface with the pedometer subsystem 180 to obtain the user activity data pertaining to the number of steps taken by the first user of the mobile device 100. For example, the threshold tracking subsystem 192 may poll the pedometer subsystem 180 for data that indicates the first user of the mobile device 100 has taken 300 steps during the current one-hour period (e.g., 10 AM-11 AM).

In some embodiments, the threshold tracking subsystem 192 may poll a device external the mobile device 100 that is responsible for tracking movement or other activity. For example, in some embodiments, the pedometer subsystem 180 may be external the mobile device 100 and may be housed in, for example, a smartwatch that is communicatively coupled to the mobile device 100 via a wireless link. In some embodiments, the threshold tracking subsystem 192 may interface with a third-party threshold tracking system (e.g., Fitbit, Strada, RunMeter) to obtain activity threshold or parameter information tracked by a third-party device associated with the third party-threshold tracking system.

Application access subsystem 194 contains code that, when executed by processor 110, may allow or deny access to one or more mobile applications 198 available on the mobile device 100. The application access subsystem 194 may allow or deny access to the one or more mobile applications 198 available on the mobile device 100 based on whether an activity threshold or parameter associated with the first user of the mobile device 100 has been achieved, as reported by the threshold tracking subsystem 192.

For example, if the first user of the mobile device 100 is required to have taken 800 steps within the current one-hour period (e.g., 10 AM-11 AM), the application access subsystem 194 may poll the threshold tracking subsystem 192 to determine whether the first user has satisfied this threshold, and then may allow/deny the first user access to the one or more mobile applications 198 based on the determination. For example, if the first user has taken 900 steps within the current one-hour period (e.g., 10 AM-11 AM), the application access subsystem 194 may allow the first user access to the one or more mobile applications 198 for one hour following the current time or for the next one-hour period (e.g., 11 AM-12 PM).

In some embodiments, the application access subsystem 194 may poll the threshold tracking subsystem 192 to determine whether or not the first user has satisfied the threshold upon each time the first user attempts to access the one or more mobile applications 198. Threshold configuration subsystem 196 contains code that, when executed by processor 110, may provide a second user of the mobile device 100 to set one or more activity thresholds or parameters for the first user of the mobile device 100. In some embodiments, the first user may be a child user and the second user may be a parent user.

In some embodiments, the threshold configuration subsystem 196 may provide the second user with a user interface (UI) presented on the display 130 of the mobile device 100 for configuring the activity threshold(s) or parameter(s) pertaining to the first user. For example, the second user may configure the activity threshold or parameter that must be satisfied over a period of time (e.g., 6 hours, 12 hours, or 24 hours). For example, the second user may configure the activity threshold or parameter for the first user, via threshold configuration subsystem 196, requiring the first user to take 10,000 steps over a 12-hour period.

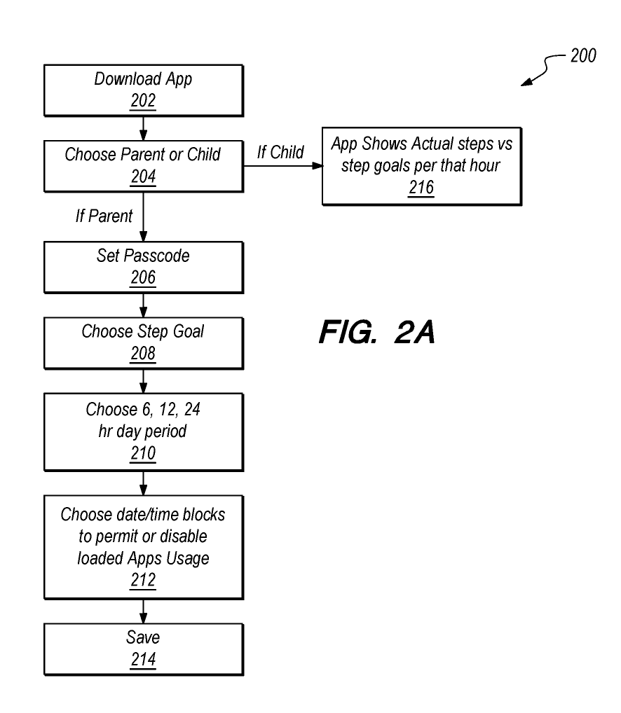

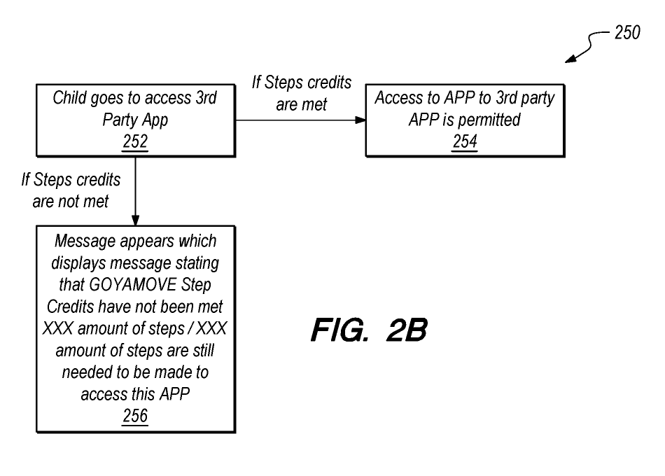

FIG. 2A is a flowchart 200 illustrating a method for configuring an activity threshold or parameter, according to some embodiments. Prior to configuring the activity threshold or parameter, at step 202, either the first user or the second user may download an application to the mobile device 100. The application may interface with the pedometer subsystem 180, threshold tracking subsystem 192, application access subsystem 194, or threshold configuration subsystem 196. After downloading the application, either the child user or parent user may open the application for the first time on the mobile device 100 via a UI presented by the display 130.

At step 204, after the application is opened by either the child use or the parent user, child user or parent user may select whether they are the child user or the parent user within the application. If the user is a parent user opening the application for the first time, the method may continue to step 206.

At step 206, after the parent user opens the application on the mobile device 100 for the first time, the parent user may set a passcode associated with the parent user for using the application as a parent user account. The passcode may be any numeric or alphanumeric combination. Upon setting the passcode, the passcode may be required for any future interaction with the application as the parent user.

At step 208, after the parent user sets the passcode associated with the parent user account, the parent user may configure an activity threshold or parameter. Configuration of the activity threshold or parameter may be facilitated by the threshold configuration subsystem 196. In some embodiments, the activity threshold or parameter may be a step threshold for the child user over a predetermined period of time. For example, the parent user may configure the step threshold to be 10,000 steps over a 12-hour period. Accordingly, the parent user may enter a step threshold of 10,000 steps. The parent user may reconfigure the step threshold at any time by launching the application, providing the passcode, and changing the configuration. During step 208, the parent user may also select one or more third-party applications provided by the mobile device for which the configured activity threshold or parameter must be satisfied by the child user prior to the child user being allowed access to those applications.

At step 210, after the parent user sets the activity threshold or parameter (e.g., 10,000 steps), the parent user may select a time period for which the activity threshold or parameter is enforced. For example, the parent user may select a 6-hour, 12-hour, 24-hour period, or any other custom time period.

At step 212, after the parent user sets the time period for which the activity threshold or parameter is enforced, the parent user may configure dates/times for which the activity threshold or parameter is enforced or accept default dates/time provided by the application. For example, the 12-hour period may run from 12 AM-12 PM at which point the 12-hour period may reset from 12 PM-12 AM. Any other configuration of a 12-hour period may also be configured by the parent user (e.g., 6 AM-6 PM and 6 PM-6 AM). Further, the parent user may configure whether the activity threshold or parameter is enforced daily, weekdays only, weekends only, or any other custom configuration.

At step 214, after the parent user configures the dates/times for which the activity threshold or parameter is enforced, the parent user may elect to save the configuration to the application and begin enforcement of the activity threshold or parameter. The parent user may also, at any time, temporarily suspend enforcement of the activity threshold or parameter by opening the application, providing the passcode for the parent user account, and electing to suspend enforcement of the activity threshold or parameter temporarily or even indefinitely.

In some embodiments, the activity threshold or parameter may be converted to a threshold-per-hour based on the configured total amount of activity and configured time period. For example, if the parent user selected a 10,000-step threshold over a 12-hour time period, the activity threshold or parameter may be converted to 833 steps per hour. Referring back to step 204, if the user is a child user, the method may continue to step 216. At step 216, the child user (e.g., first user) may be presented with a current status toward achieving the activity threshold or parameter set by the parent user (e.g., second user) as determined by the threshold tracking subsystem 192. For example, if the parent user selected a 10,000-step threshold over a 12-hour time period, and the child user has taken 300 steps during the current hour, the child user may be presented with this information along with information indicating how many more steps the child user needs to take within the current hour to satisfy the activity threshold or parameter.

In some embodiments, the parent user may access an application on a personal computer or a webpage associated with the application downloaded on the mobile device 100 for configuring the activity threshold or parameter described with respect to FIG. 2A.

FIG. 2B is a flowchart 250 illustrating a method for mobile application access based on an activity threshold or parameter, according to some embodiments.

In FIG. 2B, at step 252, a child user may attempt to access a third-party application on the mobile device 100. The third-party application may be a social networking application, photo application, video application, gaming application, or any other third-party application provided by the mobile device 100. Any attempt to access a third-party application on the mobile device 100 may first be intercepted by the application access subsystem 194. The application access subsystem 194 may then determine, by polling the threshold tracking subsystem 192, whether or not the activity threshold or parameter configured by the parent user has been achieved by the child user.

If the activity threshold or parameter has been achieved by the child user, the method may continue to step 254, the child user may be allowed access to the third-party application, and the application access subsystem 194 may allow the third-party application to launch. For example, if the user taken 900 steps within the current one-hour period, the application access subsystem 194 may allow access to the third-party application. In some embodiments, the access to the third-party application may be provided immediately while in other embodiments the access to the third-party application may be provided at a future time (e.g., at the start of the next one-hour period). In some embodiments, access to the application may only be provided for a predetermined period of time (e.g., thirty minutes, one hour, etc.).

If the activity threshold or parameter has not been achieved by the child user, the method may continue to step 256. At step 256, the application access subsystem 194 may display a notification via the UI of the application notifying the child user that the activity threshold or parameter has not yet been achieved. Additionally, the application access subsystem 194 may provide the current status toward achieving the activity threshold or parameter as reported by the threshold tracking subsystem 192. For example, if the child user has only taken 500 steps during the current one-hour period, the application may notify the child user that he/she must take an additional 333 steps during the current one-hour period prior to being allowed access to the requested third-party application. The application access subsystem 194 may also terminate the launching of the requested third-party application at this time.

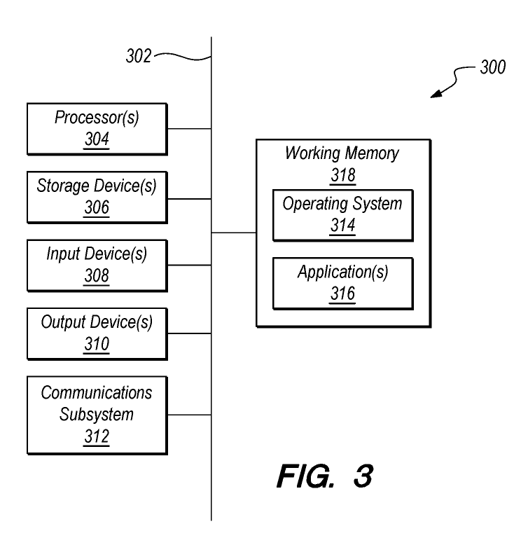

FIG. 3 illustrates an example of a computing system in which one or more embodiments may be implemented.

In FIG. 3, a computer system as illustrated may be incorporated as part of the above described mobile device 100 or the above described server computer (not shown). For example, computer system 300 can represent some of the components of a television, a computing device, a server, a desktop, a workstation, a control or interaction system in an automobile, a tablet, a netbook or any other suitable computing system. A computing device may be any computing device with an image capture device or input sensory unit and a user output device. An image capture device or input sensory unit may be a camera device. A user output device may be a display unit. Examples of a computing device include but are not limited to video game consoles, tablets, smart phones and any other hand-held devices. FIG. 3 provides a schematic illustration of one embodiment of a computer system 300 that can perform the methods provided by various other embodiments, as described herein, and/or can function as the host computer system, a remote kiosk/terminal, a point-of-sale device, a telephonic or navigation or multimedia interface in an automobile, a computing device, a set-top box, a table computer and/or a computer system. FIG. 3 is meant only to provide a generalized illustration of various components, any or all of which may be utilized as appropriate. FIG. 3, therefore, broadly illustrates how individual system elements may be implemented in a relatively separated or relatively more integrated manner. In some embodiments, elements computer system 300 may be used to implement functionality of mobile device 100 in FIG. 1.

The computer system 300 is shown comprising hardware elements that can be electrically coupled via a bus 302 (or may otherwise be in communication, as appropriate). The hardware elements may include one or more processors 304, including without limitation one or more special-purpose processors and a display unit such as the device used in embodiments of the disclosure, a printer and/or the like.

The computer system 300 might also include a communications subsystem 312, which can include without limitation a modem, a network card (wireless or wired), an infrared device, a wireless device and/or chipset (such as a Bluetooth™ device, an 802.11 device, a Wi-Fi device, a WiMax device, cellular communication facilities, etc.), and/or the like. The communications subsystem 312 may permit data to be exchanged with a network, other computer systems, and/or any other devices described herein.

The computer system 300 also can comprise software elements, shown as being currently located within the working memory 318, including an operating system 314, device drivers, executable libraries, and/or other code, such as one or more application programs 316, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 306 described above. In some cases, the storage medium might be incorporated within a computer system, such as computer system 300. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 300 and/or might take the form of source and/or installable code, which, upon compilation and/or installation on the computer system 300 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed. In some embodiments, one or more elements of the computer system 300 may be omitted or may be implemented separate from the illustrated system. For example, the processor 304 and/or other elements may be implemented separate from the input device 308. In one embodiment, the processor is configured to receive images from one or more cameras that are separately implemented. In some embodiments, elements in addition to those illustrated in FIG. 3 may be included in the computer system 300.

Some embodiments may employ a computer system (such as the computer system 300) to perform methods in accordance with the disclosure. For example, some or all of the procedures of the described methods may be performed by the computer system 300 in response to processor 304 executing one or more sequences of one or more instructions (which might be incorporated into the operating system 314 and/or other code, such as an application program 316) contained in the working memory 318. Such instructions may be read into the working memory 318 from another computer- readable medium, such as one or more of the storage device(s) 306. Merely by way of example, execution of the sequences of instructions contained in the working memory 318 might cause the processor(s) 304 to perform one or more procedures of the methods described herein.

The terms “machine-readable medium” and “computer-readable medium,” as used herein, refer to any medium that participates in providing data that causes a machine to operate in a specific fashion. In some embodiments implemented using the computer system 300, various computer-readable media might be involved in providing instructions/code to processor(s) 304 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 306. Volatile media include, without limitation, dynamic memory, such as the working memory 318.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 304 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 300. These signals, which might be in the form of electromagnetic signals, acoustic signals, optical signals and/or the like, are all examples of carrier waves on which instructions can be encoded, in accordance with various embodiments of the disclosure.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Also, some embodiments are described as processes depicted as flow diagrams or block diagrams. Although each may describe the operations as a sequential process, many of the operations can be performed in parallel or concurrently. In addition, the order of the operations may be rearranged. A process may have additional steps not included in the figures. Furthermore, embodiments of the methods may be implemented by hardware, software, firmware, middleware, microcode, hardware description languages, or any combination thereof.

When implemented in software, firmware, middleware, or microcode, the program code or code segments to perform the associated tasks may be stored in a computer-readable medium such as a storage medium. Processors may perform the associated tasks. Thus, in the description above, functions or methods that are described as being performed by the computer system may be performed by a processor—for example, the processor 304—configured to perform the functions or methods. Further, such functions or methods may be performed by a processor executing instructions stored on one or more computer readable media.

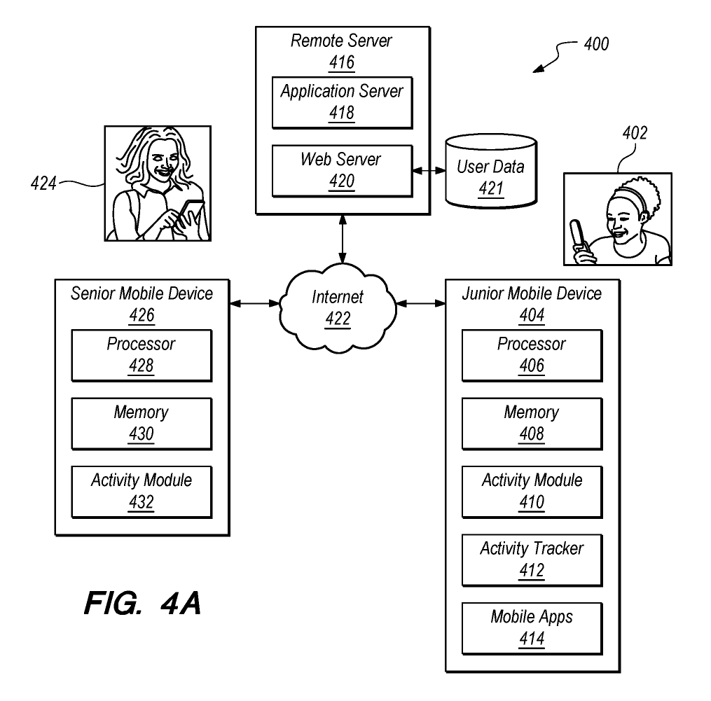

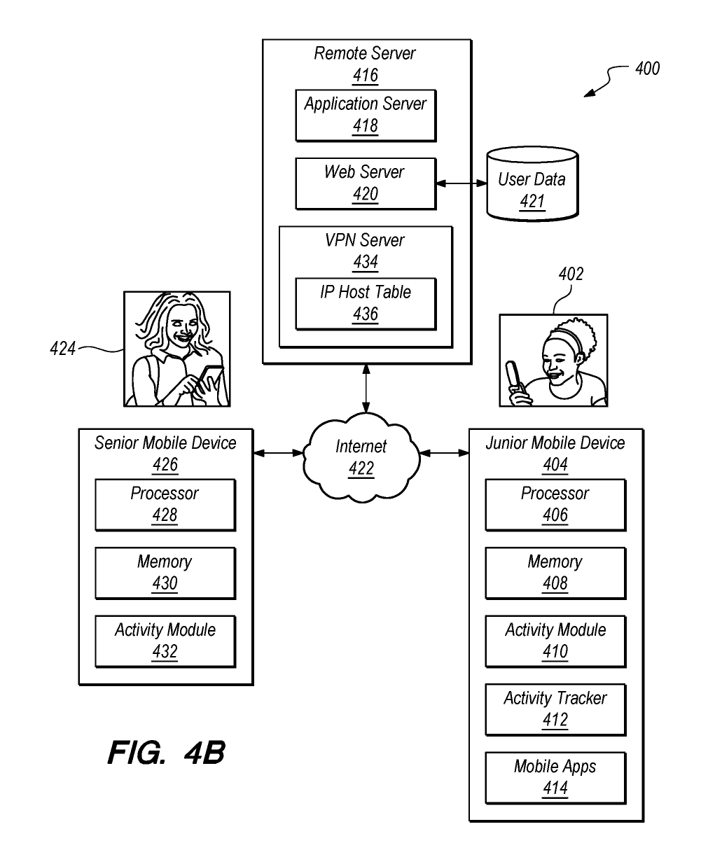

FIG. 4A illustrates activity threshold execution system 400 according to another exemplary embodiment of the present disclosure.

In FIG. 4A, activity threshold execution system 400 comprises junior mobile device user 402 communicably coupled to remote server 416 via Internet 422. Internet 422, may be any communication network wired or wireless that permits point-to-point data communication.

Here, junior mobile device user 402 uses junior mobile device 404 for communication with remote server 416. Remote server 416 might include application server 418, web server 420 and user data store 421 for storing user data. In one embodiment, such user data might include activity threshold information defining activity parameters that must be met by junior mobile device user 402. Here, web server 420 and application server 418 cooperatively provide access control services and can generate content for mobile apps 414 residing on junior mobile device 404. Such content may be text, graphics, audio, and/or video that can be served up to junior mobile device 404 in form of HTML, DHTML, XML or another appropriate structured language for example.

In FIG. 4A, among other components, junior mobile device 404 includes processor 406 and memory 408. In one embodiment, processor 406 might be a special-purpose computing device such as an ASIC (Application-Specific Integrated Circuit) or SoC (Systems on a Chip) programed to perform specific functionality in accordance with advantages of the present disclosure. Other components of junior mobile device 404 include activity module 410, activity tracker 412 and one or more mobile apps 414.

Activity module 410 is configured to receive activity threshold data from remote server 416 and in conjunction with activity tracker 412 can determine whether an activity threshold has been met. Activity module 410 may 1) send a message to activity tracker 412 to receive user activity data; 2) if there is no data, a null response is returned; otherwise, the user activity data is sent to activity module 410; 3) If the user activity data meets the activity threshold specified by senior mobile device user 424, the execution of one or more mobile apps 414 selected by junior mobile device user 402 is permitted. In one embodiment, mobile apps 414 might include a stand-alone application. In another embodiment, mobile apps 414 might include a server-based application such as Instagram® for example.

In FIG. 4A, activity threshold execution system 400 further comprises a second user, namely senior mobile device user 424 also communicably coupled to remote server 416 via Internet 422. Here, senior mobile device user 424 employs senior mobile device 426 for communication with remote server 416 to manage the execution of mobile apps 414 on junior mobile device 404. In other words, senior mobile device user 424/senior mobile device 426 can control junior mobile device user 402/junior mobile device 404 by setting activity thresholds, the non-fulfillment of which would disable or prevent initiation of one or more mobile apps 414 designated by senior mobile device user 424.

In one embodiment, an advantage of the present disclosure, is that control of a first device and associated activities thereof is accomplished by a second remote device, senior mobile device user 424 which establishes the conditions under which junior mobile device 404 is operated, such control being accomplished without physical access to the controlled junior mobile device 404. Such control may facilitate physical activity of junior mobile users, the benefit of such physical activity including increased fitness and healthy body functions.

In one embodiment, the term “senior” mobile device user might indicate a “parent” while the term “junior” mobile device user indicates a “child.” Thus, the terms senior/junior are used to reflect a parent/child relationship or other such familial relationship involving guardianship. In another embodiment, the term “senior” mobile device user might indicate a “principal” while the term “junior” mobile device user indicates an “agent,” so that the terms reflect a fiduciary relationship. In another embodiment, the term “senior” mobile device user might indicate an “employer” while the term “junior” mobile device user indicates an “employee,” so that the terms reflect an employer/employee relationship. One skilled in the art will understand that the present disclosure is applicable to other relationship types.

In FIG. 4A, senior mobile device 426 of the activity threshold execution system 400 further comprises processor 428, memory 430 and activity module 432. Activity module 432 is configured to receive and upload, to remote server 416, activity threshold parameters to be met by junior mobile device 404. In turn, in one embodiment, remote server 416 then delivers said activity threshold parameters to junior mobile device 404. In another embodiment, remote server 416 does not deliver said activity threshold parameters to junior mobile device 404 but said activity threshold parameters are stored in user data store 421. Thereafter, activity data for junior mobile device user 404 is received by remote server 416 for determining whether the activity threshold parameters are met based on information stored in user data store 421.

In use, and in general, senior mobile device user 424 (e.g., a parent) begins by installing activity module 432 (named “Goya-Move” by the present inventor) onto senior mobile device 426. Upon successful installation, senior mobile device user 424 then installs onto junior mobile device 404, an activity module 410 configured for the junior mobile device. Activity module 410 is configured such that junior mobile device 404 is manageable by senior mobile device user 424 based on predetermined activity threshold or parameters.

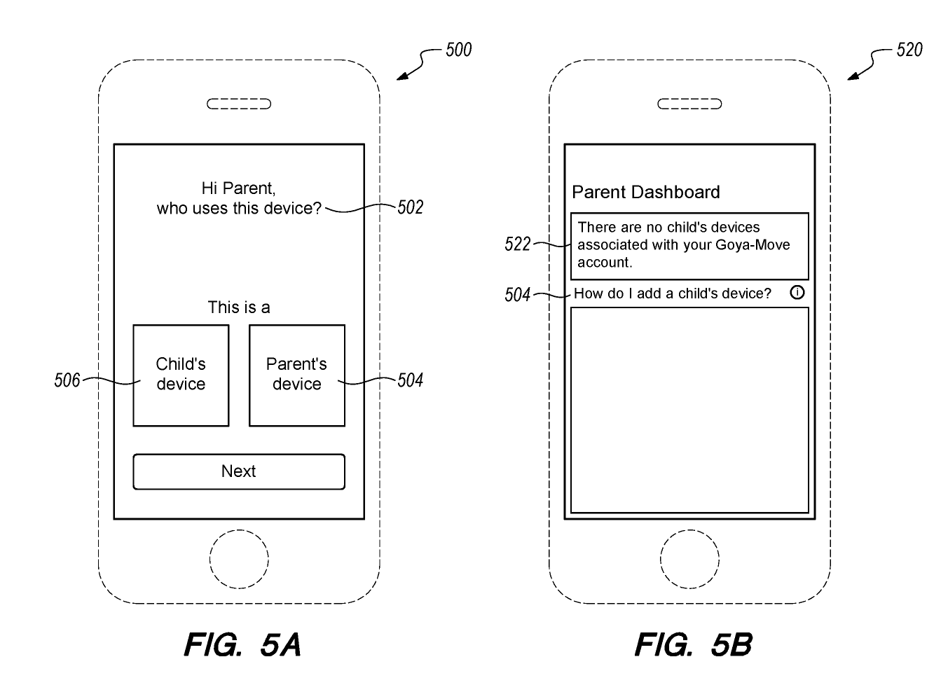

More specifically, after the parent or senior mobile device user 424 installs activity module 432, the activity module 432 is initiated. Once initiated, the user for which the device is intended is designated. Here, the system displays interface 500 of FIG. 5A. As shown, interface 500 asks “Hi Parent, who uses this device?” at 502. Senior mobile device user 424 can then select option 504 to indicate that senior mobile device 426 is a parent's device. Interface 520 of FIG. 5B shows a Parent Dashboard that might be displayed after indicating that senior mobile device 426 is a parent's device. As can be seen at 522, for this parent device, there are no child's devices associated with it at the present moment. Instructions for adding a child's device are available by selecting “How do I add a child's device?” 504.

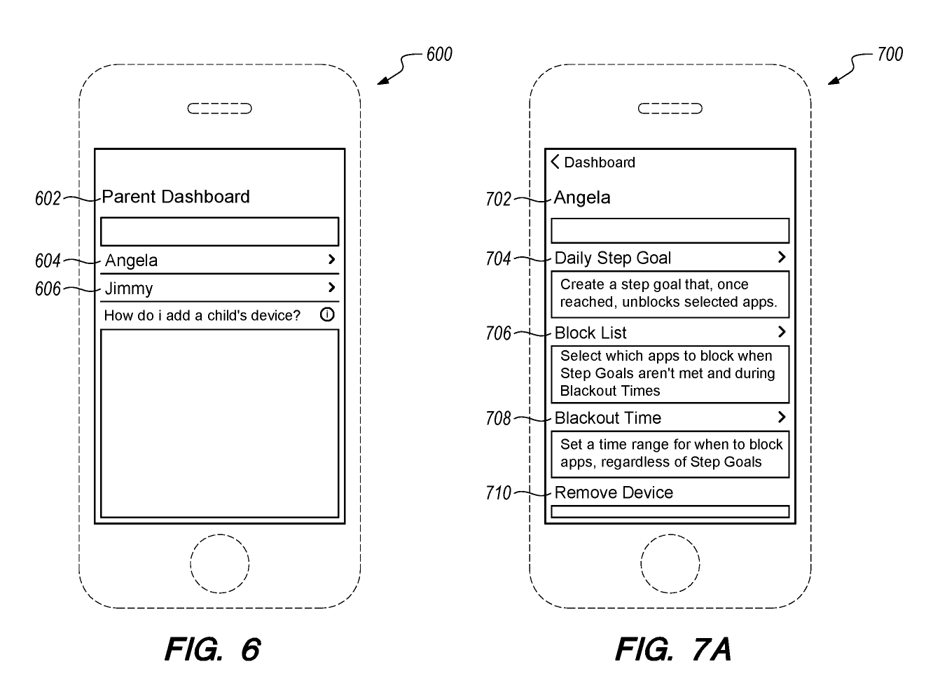

In order to add a child's device, senior mobile device user 424 (FIG. 4A) begins by downloading and installing activity module 410 onto junior mobile device 404. The activity module 410 is then initiated, followed by a sign-in into the Goya-Move account of senior mobile device user. Once signed into the senior mobile device user account, the user for which the device is intended is again designated as in interface 500 of FIG. 5A. Here, in response to “Hi Parent, who uses this device?” 502, senior mobile device user 424 selects “Child's device” 506 to indicate that the installed activity module 410 is for a child's device. The child's device (junior mobile device 404) now appears on the parent dashboard 602 of interface 600 of FIG. 6, ready to set activity threshold parameters.

In FIG. 6, senior mobile device user 424 (FIG. 4A) has added two child devices, a mobile device for Angela 604 and another mobile device for Jimmy 606. The present disclosure permits the addition of not only a single mobile device but multiple devices as well given that a parent can have more than one child. Thus, the technical challenge of associating multiple junior mobile devices with a single senior mobile device is overcome. An API (Application Programming Interface) named “Request for Enrolled Devices” is used by activity module 410 to send an http protocol GET request to remote server 416 to obtain all of the child/junior mobile devices under the senior user or parent, such that the senior user or parent can establish threshold parameters for each device. An example of API is as follows.

Name: Request for Enrolled Devices:
GET: https://goya-move-production.herokuapp.com/api/v1/user/devices
Headers:
Accept:application/json
Content-Type: application/json
access-token: _xxxgZdMXfFIxSsSm_9dKojA
uid: peter.smith@rootstrap.com
Client: MKdCWk4Lem1kDQykDLSOJ_
Response:
{ “devices”: [ { “id”: 5, “name”: “Angela”] “mobile_id”:
“3CD71EBC-CDE8-40D1-9850-4844B1BD9431”, “user”:
{ “id”: 3, “email”: german.pereyra@bootstrap.com, “username”:
“german” }, “step_threshold”: { “id”: 1, “daily_step_threshold”:
1000, “hourly_step_threshold”: 1428, “hourly_threshold”:
true, “from_time”: “07:00 AM”, “to_time”: “12:00 AM”, “days”:
“weekdays” }, “blackout_on”: false, “today_steps”:
0, “steps_per_hour”: { } }
]
}

Among other information, the response from remote server 416 includes the child's information for Angela and other information such as daily and hourly step threshold, and from time and to time and whether black out is on or off. In this exemplary embodiment, a single child is depicted in the API response above but multiple children can be saved for a parent. The senior mobile device user 424 now sets up the activity threshold parameters for child Angela.

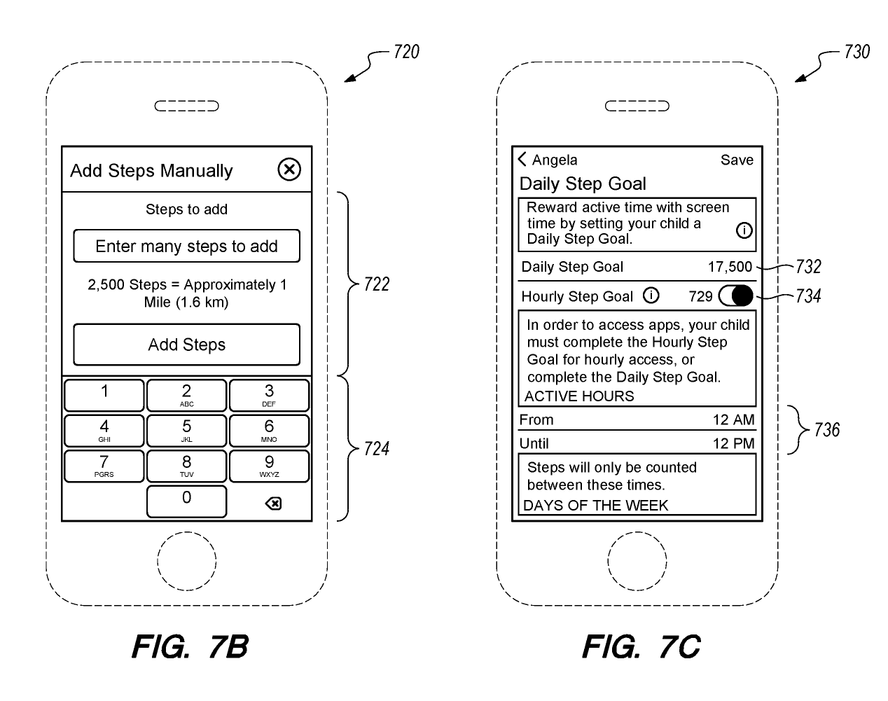

FIG. 7A illustrates interface 700 for setting activity threshold parameters according to an exemplary embodiment of the present disclosure.

In FIG. 7A, interface 700 shows the dashboard for child Angela 702. As shown, daily step threshold 704 and block list 706 can be set by senior mobile device user 424. Daily step threshold 704 allows creation of an activity threshold. In one embodiment, the activities might be the number of steps taken by junior mobile device user 402 within a 24-hour time span. In another embodiment, the activities might be the number of flights/stairs taken by junior mobile device user 402. One skilled in the art will readily understand that the present disclosure is applicable to multiple activities. FIG. 7A also indicates black out time (no apps active) 708 and remove device 710 to remove a device.

FIG. 7B shows interface 720 for entering step activity thresholds manually according to an embodiment of the present disclosure. At “Steps to add” 722, senior mobile device user 424 can enter the number steps by using keypad 724. FIG. 7C shows interface 730 for setting daily step thresholds 732 or hourly step thresholds 734. At 736, the steps are counted between the indicated intervals.

Here, once the entered step threshold is met, all mobile apps 414 become unblocked for the remainder of the time period. In another embodiment, hourly step thresholds may be set, which divides the daily step threshold by the number of hours in an “Active Hour” selection. Once the threshold is met, mobile apps 414 are unblocked for the remainder of the hour.

In order for unblocking to occur, in one embodiment, the number of steps required to unblock mobile apps 414 is obtained from user data store 421 and delivered to junior mobile device 404. Activity module 410 then obtains, from activity tracker 412, the number of steps taken by junior mobile device user 402 to determine whether the threshold is met. Activity tracker 412 may itself include a pedometer. In another embodiment, the steps taken by junior mobile device user 402 is periodically polled for reporting to remote server 416 so that mobile apps 414 can be unblocked if the threshold is met. An exemplary API named “Send Child's Steps” is used by activity module 410 to send an http protocol PUT message to remote server 416 to deliver the walked steps for junior mobile device 402 (FIG. 4A) such that specified mobile apps can be unblocked. An example API is as follows.

Name: Send Child's Steps
PUT: https://goya-move-
production.herokuapp.com/api/v1/user/devices/39/steps
Headers:
Accept:application/json
Content-Type: application/json
access-token: FYgZdMXfFIxSsSm_9dKojA
uid: angela@gmail.com
Client: MKdCWk4Lem1kDQykDLSOJA
Body:
{ “device”: { “steps”: 400 } }
Response:
{ “device”: { “id”: 39, “name”: “Angela”, “mobile_id”:
“819EB882-CF70-46C8-BB9C-D9466AC653D1”, “user”: { “id”:
3, “email”: “angela@gmail.com”, “username”: “Angela” },
“step_threshold”: { “id”: 10, “daily_step_threshold”: 10000,
“hourly_step_threshold”: 416, “hourly_threshold”: false,
“from_time”: “12:00 AM”, “to_time”: “12:00 PM”, “days”:
“everyday” }, “blackout_on”: false, “today_steps”:
400, “steps_per_hour”: { “21/02/2018 13 +0000”: 400 } } }

As noted above, in order for unblocking to occur, in one embodiment, the number of steps taken by junior mobile device user 402 is periodically transmitted to remote server 416 so that mobile apps 414 can be unblocked if the threshold is met. In this regard, one technical challenge overcome by the present disclosure is how to block mobile apps 414 on the child's devices since there can be hundreds of apps that point to different servers or hosts. As illustrated in FIG. 4B, the disclosure solved this issue by using a VPN server 434 which captures the traffic and stops every request that doesn't point to remote server 416 endpoints. Once VPN server 434 is configured any network traffic is routed through VPN server 434 and only has broadband access through it. At the junior mobile device 404 end, a service can be used to turn on/off the VPN remotely.

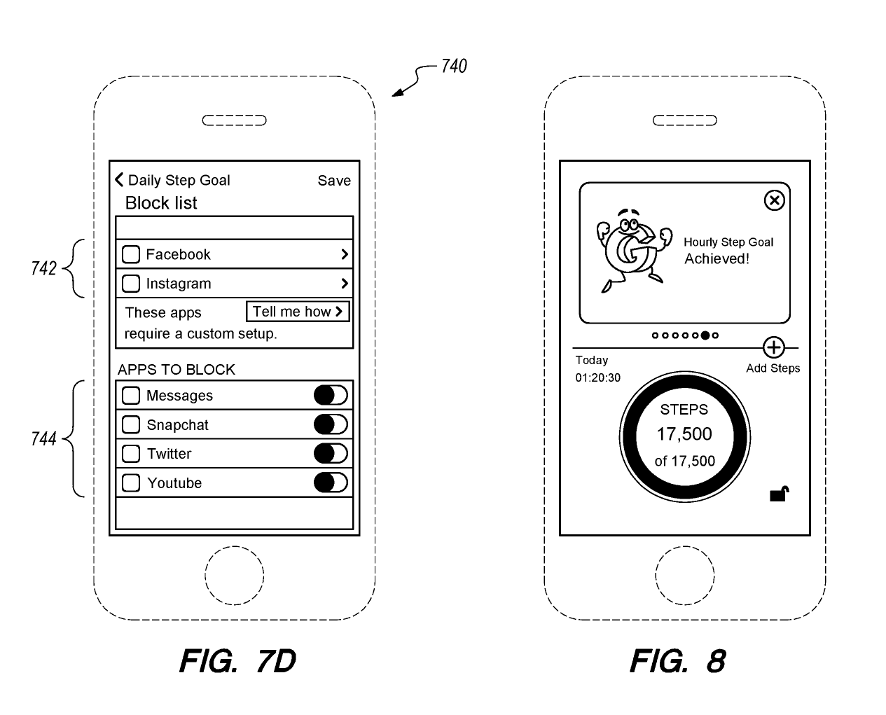

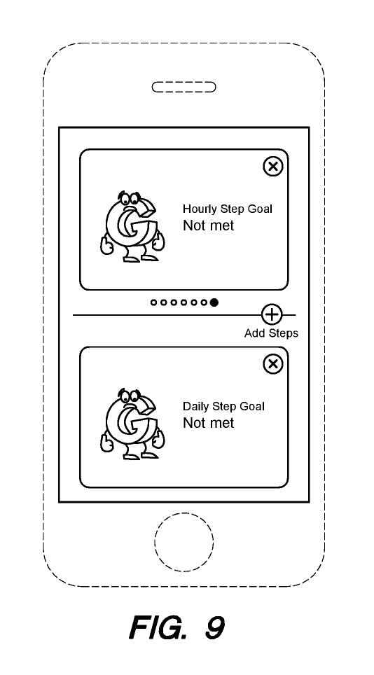

In operation, given that VPN server 434 (FIG. 4B) is fully configured and operating, when senior mobile device user 424 selects one or more mobile apps 414 to block, a backend API web service is executed. This backend then connects to VPN server 434 over SSH (Secure Socket Shell). The backend overrides IPhosts table (configuration table) 436 of VPN server 434 (FIG. 4B)), adding a few entries for the new service and user. VPN server 434 then begins to block specific IPs for that specific user until the activity threshold is met. Once the threshold is met, the entries in IPhosts table 436 are then deleted to unblock the mobile apps 414. FIG. 8 shows a notification that a step threshold is met. FIG. 9 shows an interface that step thresholds are not met.

An embodiment of the present disclosure reduces time spent on mobile devices by restricting access to applications on such devices based on whether or not an activity threshold or parameter set for the device has been satisfied. A senior mobile device user may also manually credit towards the activity threshold or parameter if necessary. For example, if the junior mobile device user participated in an activity known by the senior mobile device user, where the device was not present to track the activity, the senior mobile device user may manually add credit toward the junior mobile device user satisfying the activity threshold or parameter.

While the above is a complete description of exemplary specific embodiments of the disclosure, additional embodiments are also possible. Thus, the above description should not be taken as limiting the scope of the disclosure, which is defined by the appended claims along with their full scope of equivalents.

I claim:

1. A system comprising:
a remote server incorporating a processor and memory;
a senior mobile device incorporating a processor and memory;
a junior mobile device incorporating a processor and memory, the junior mobile device communicably coupled through the remote server to the senior mobile device, the junior mobile device executing one or more mobile applications based on a user input signal from a user of said junior mobile device to execute the one or more mobile applications;
an activity requirement module executed on the senior mobile device and on said junior mobile device, the activity requirement module communicating, from the senior mobile device to junior mobile device via the remote server, at least one predetermined activity threshold or parameter that is to be met by the junior mobile device user; and
an activity tracker module associated with the junior mobile device, the activity tracker module tracking movement activities of the junior mobile device or user,
wherein upon receiving the user input signal to execute the one or more mobile applications, the activity requirement module of the junior mobile device uses the activity tracker module to determine whether the least one predetermined activity threshold or parameter is met,
if so, executing the one or more mobile applications to permit access by the junior mobile device user; and if said at least one predetermined activity threshold or parameter is not met, disabling or denying access to the one or more mobile applications.

2. The system of claim 1 further comprising a remote database that stores said at least one predetermined activity threshold or parameter received from the senior junior mobile user.

3. The system of claim 1 further comprising a VPN server, wherein the disabling or denying access to the one or more mobile applications is by using the VPN server to create a virtual private network through which all network traffic from the junior mobile device is routed.

4. The system of claim 3 wherein the disabling or denying access to the one or more mobile applications is by modifying a configuration table of said VPN server to enter information that identifies the junior mobile device and the one or more mobile applications that are blocked.

5. The system of claim 3 wherein executing the one or more mobile applications to permit access by the junior mobile device user is by modifying a configuration table of said VPN server to delete information that identifies the junior mobile device and the one or more applications that are blocked.

6. The system of claim 1 wherein the senior mobile device comprises a graphical user interface display having an area with an activity parameter input menu that accepts the one predetermined activity threshold or parameter as entered by a user of the senior mobile device.

7. The system of claim 1 wherein the senior mobile device comprises a graphical user interface display having an area with a selectable menu list of a plurality of mobile applications that are disabled but enabled when the at least one predetermined threshold or parameter is met.

8. The system of claim 1 wherein the senior mobile device comprises a graphical user interface display having an area with a mobile application duration input menu that accepts for a plurality of selected mobile applications on the junior mobile device, a duration for which the plurality of selected mobile applications remains active after the at least one predetermined activity threshold or parameter is met.

9. The system of claim 1 wherein the junior mobile device comprises a graphical user interface display designating a user of the junior mobile device by selecting between the senior mobile device user and the junior mobile device user.

10. The system of claim 1 wherein the activity tracker module is a pedometer.

11. The system of claim 1 wherein the at least one predetermined activity threshold or parameter is a number of steps counted by a pedometer when the junior mobile device user engages in an activity.

12. The system of claim 1 wherein the at least one predetermined activity threshold or parameter is a number of steps counted by a pedometer within a predetermined time period after the junior mobile device user engages in an activity.

13. A system comprising:
a mobile device incorporating a processor and memory, the mobile device executing one or more mobile applications based on a user input signal from a user of said mobile device to execute the one or more mobile applications;
an activity requirement module executed on the mobile device, the activity requirement module receiving at least one predetermined activity threshold or parameter that is to be met by the mobile device user to initiate launch of the one or more mobile applications; and
an activity tracker module associated with the mobile device, the activity tracker module tracking movement activities of the mobile device or user,
wherein upon receiving the user input signal to execute the one or more mobile applications, the activity requirement module of the mobile device uses the activity tracker module to determine whether the least one predetermined activity threshold or parameter is met;
if so, executing the one or more mobile applications to permit access by the mobile device user; and if said at least one predetermined activity threshold or parameter is not met, disabling or denying access to the one or more mobile applications.

14. The system of claim 13 wherein the mobile device comprises a graphical user interface display having an area with an activity parameter input menu that accepts the at least one predetermined activity threshold or parameter as entered by a second user of the mobile device.

15. The system of claim 13 wherein the mobile device comprises a graphical user interface display having an area with a selectable menu list of a plurality of mobile applications that can be enabled when the at least one predetermined threshold or parameter is met.

16. The system of claim 13 further comprising:
a remote server incorporating a processor and memory; and
a VPN server, wherein the disabling or denying access to the one or more mobile applications is by using the VPN server to create a virtual private network through which all network traffic from the mobile device is routed,
wherein the disabling or denying access to the one or more mobile applications is by the remote server modifying a configuration table of said VPN server to enter information that identifies the mobile device and the one or more mobile applications that are blocked.

17. The system of claim 16 wherein executing the one or more mobile applications to permit access by the mobile device user is by the remote server modifying a configuration table of said VPN server to delete information that identifies the mobile device and the one or more applications that are blocked.

18. A method comprising:
executing, by a mobile device, one or more mobile applications based on a user input signal from a user of said mobile device to execute the one or more mobile applications;
receiving, by an activity requirement module executed on the mobile device and, from a second user, at least one predetermined activity threshold or parameter that is to be met by the mobile device user; and
tracking, by an activity tracker module associated with the mobile device, movement activities of the mobile device user,
wherein upon receiving the user input signal to execute the one or more mobile applications, the activity requirement module of the mobile device uses the activity tracker module to determine whether the least one predetermined activity threshold or parameter is met,
if so, executing the one or more mobile applications to permit access by the mobile device user; and if said at least one predetermined activity threshold or parameter is not met, disabling or denying access to the one or more mobile applications.

19. The method of claim 18 further comprising, creating, with a VPN server, a virtual private network through which all network traffic for the junior mobile device is routed; and
disabling or denying access to the one or more mobile applications is by modifying a configuration table of said VPN server to enter information that identifies the junior mobile device and the one or more mobile applications that are blocked.

20. The method of claim 18 wherein executing the one or more mobile applications to permit access by the junior mobile device user is by modifying a configuration table of said VPN server to delete information that identifies the junior mobile device and the one or more applications that are blocked.
